(19) United States
(12) Patent Application Publication
(10) Pub. No.: US 2025/0121642 A1
(43) Pub. Date: Apr. 17, 2025

(54) FUNCTIONAL SAFETY TEST FOR HIGH ASIL AUTOMOTIVE SYSTEMS

(71) Applicant: JAGUAR LAND ROVER LIMITED, Warwickshire (GB)

(72) Inventors: Adrian Bouaru, Whitley, Coventry, Warwickshire (GB); Thomas Papanikolaou, Whitley, Coventry, Warwickshire (GB)

(21) Appl. No.: 18/702,451

(22) PCT Filed: Oct. 18, 2021
(86) PCT No.: PCT/EP2021/078800

§ 371 Date: Apr. 18, 2024

(51) Int. Cl. B60G 17/017; B60G 17/0185; B60G 21/055

(52) U.S. Cl. CPC B60G 17/017; B60G 17/0185; B60G 21/0551; B60G 2400/204; B60G 2400/252; B60G 2800/20; B60G 2800/802

(57) ABSTRACT

A control system (100, 200) for a vehicle suspension system of a vehicle (700). The vehicle suspension system comprises an actuator coupled an anti-roll bar. The control system is configured to: receive a vehicle stationary signal (304, 404) indicative of the vehicle being stationary; output a passive state request signal to the actuator of the vehicle suspension system (306) in dependence on receipt of the vehicle stationary signal, wherein the passive state request signal is configured to prevent the actuator from responding to a received torque demand; receive a passive state confirmation signal (308) indicative that the actuator is in a passive state; output a torque demand to the actuator (310) in dependence on the passive state confirmation signal; receive a sensor response signal (312) from a sensor configured to sense a torque level of the anti-roll bar; and output a fault signal (316) in dependence on receipt of the sensor response signal indicating the torque level of the anti-roll bar is above a predetermined threshold.

### TECHNICAL FIELD

The present disclosure relates to a functional safety test for high ASIL automotive systems. Aspects of the invention relate to a control system, to a system, to a vehicle, to a method, and to computer software.

### BACKGROUND

Vehicles (for example petrol, diesel, electric, hybrid) may comprise active suspension systems, such as electronic active roll control systems, for maintaining vehicle stability. Such electronic active roll control systems comprise at least one actuator, the actuator being coupled to an anti-roll bar and configured to actively impart motor control on the suspension system. Faults arising from an electronic active roll control system, such as unintended actuation (and, consequently, imparted motor control), can lead to undesired path deviation by the vehicle. The electronic active roll control system therefore has a high functional safety integrity requirement (for example a high Automotive Safety Integrity Level (ASIL) rating). Throughout this disclosure, the term “anti-roll bar” is used and is synonymous with the terms “roll bar”, “anti-sway bar”, “sway bar” or “stabilizer bar”.

Such active suspension systems may include a number of individual subcomponents or mechatronic subsystems. There may be a high level vehicle control generating a system demand signal, for example a torque demand signal, to influence vehicle motion. There may be a low level controller providing control signals to an actuator (for example to provide motor control) of the active suspension system, to deliver the demanded signal provided. There may be associated mechanical or electromechanical components to deliver a physical manifestation of the demanded signal, for example a motor. There may be a dedicated power supply system. There may be significant interaction between these subsystems in order to provide operation of the active suspension system.

In view of the high functional safety requirement of the electronic active roll control system, it is desirable to be able to pre-emptively diagnose a system failure which may arise within the electronic active roll control system, including the individual subcomponents of the system, before any undesired, potentially hazardous situation occurs. It may be desirable to frequently perform a functional safety test of communication between the controller and the electronic active roll control system, particularly during active use of the vehicle, to help prevent any such situation occurring. However, during active use of the vehicle, it may be difficult to perform a functional test on the electronic active roll control system, in order to pre-emptively diagnose any system faults, because such functional testing may impair the vehicle performance if, for example, an actuator is activated for the purposes of a test but is not required for actuation for controlling the vehicle as desired by the driver. Such actuation for testing purposes may also potentially may damage subcomponents of the system.

Therefore, it is an aim of the present invention to address one or more of the disadvantages associated with the prior art.

### SUMMARY OF THE INVENTION

A possible solution to the above-detailed problem is to perform a functional safety test on the ASIL system, when specific conditions of the vehicle are detected. Such conditions may apply when the vehicle is stationary (i.e. on initial start up of the vehicle, or when the vehicle has temporarily stopped). This allows for the electronic active roll control system to be tested in a non-intrusive manner, without affecting vehicle performance.

Aspects and embodiments of the invention disclosed herein provide a control system, to a system, to a vehicle, to a method, and computer software, as claimed in the appended claims.

According to an aspect of the present invention there is provided a control system for a vehicle suspension system of a vehicle, the control system for performing a test cycle for testing communication between the control system and the vehicle suspension system, the control system comprising one or more controllers and the vehicle suspension system comprising an actuator coupled an anti-roll bar, the control system configured to: receive a vehicle stationary signal indicative of the vehicle being stationary; output a passive state request signal to the actuator of the vehicle suspension system in dependence on receipt of the vehicle stationary signal, wherein the passive state request signal is configured to prevent the actuator from responding to a received torque demand; receive a passive state confirmation signal indicative that the actuator is in a passive state; output a torque demand to the actuator in dependence on the passive state confirmation signal; receive a sensor response signal from a sensor configured to sense a torque level of the anti-roll bar; and output a fault signal in dependence on receipt of the sensor response signal indicating the torque level of the anti-roll bar is above a predetermined threshold.

According to an aspect there is provided a control system for a vehicle suspension system of a vehicle, the control system for performing a test cycle for testing communication between the control system and the vehicle suspension system comprising an actuator, the control system comprising one or more controllers. The control system is configured to: receive a vehicle stationary signal indicative of the vehicle being stationary; output a passive state request signal to the actuator of the vehicle suspension system in dependence on receipt of the vehicle stationary signal, wherein the passive state request signal is configured to prevent the actuator from responding to a received torque demand; receive a passive state confirmation signal indicative that the actuator is in a passive state; output a torque demand to the actuator in dependence on the passive state confirmation signal; receive a sensor response signal from a sensor configured to sense a torque level at the actuator; and output a fault signal in dependence on receipt of the sensor response signal indicating the torque level at the actuator is above a predetermined threshold.

The torque demand may switch the torque demand between a zero and non-zero value.

The control system may be further configured to alternately provide the torque demand to: an actuator of a front axle of the vehicle, and an actuator of a rear axle of the vehicle.

The sensor response signal may be received from: at least one torque sensor located on the front axle, and at least one torque sensor located on the rear axle.

The control system may be further configured to, in dependence on receipt of the sensor response signal indicating that the torque level of the anti-roll bar is above the predetermined threshold, reduce the torque demand to zero.

The control system may be further configured to, when the vehicle is stationary at different points in time during a drive cycle: receive a plurality of vehicle stationary indicators each indicative of the vehicle being stationary for each of the different points in time during the drive cycle; and output a plurality of respective passive state request signals each in response to a respective vehicle stationary indicator of the plurality of vehicle stationary indicators.

The control system may be further configured to, during the drive cycle: in dependence on receipt of a passive state confirmation signal in response to each of the plurality of respective passive state request signals, record a plurality of sensor response signals each received in response to a respective torque demand of each of the plurality of passive state confirmation signals; and decrease a frequency for repeating the test cycle in response to receipt of further vehicle stationary indicators for a current drive cycle if a pre-set number of recorded responses fail to indicate the torque level is above a predetermined threshold.

The control system may be further configured to determine that the vehicle is stationary when the vehicle stationary indicator indicates movement below a predetermined value. The vehicle stationary indicator may be received from one or more of a movement of at least one suspension height sensor of the vehicle, and a speed of the vehicle.

The control system may be further configured to, following provision of the passive state request signal, and prior to provision of the torque demand: monitor for receipt of a vehicle movement indicator indicating vehicle movement exceeding a predetermined value; and in dependence on receipt of the vehicle movement indicator exceeding the predetermined value, abort a current test cycle. The vehicle movement indicator may indicate at least one of: a movement of at least one suspension height sensor of the vehicle, and a speed of the vehicle.

In another aspect there is provided a system, comprising: any control system disclosed herein; a vehicle suspension system comprising at least one actuator and an anti-roll bar; and at least one sensor configured to sense a torque level of the anti-roll bar.

In another aspect there is provided a vehicle comprising any control system or system disclosed herein.

In another aspect there is provided a method for a control system for a vehicle suspension system in a vehicle, the control system comprising one or more controllers and the vehicle suspension system comprising an actuator coupled to an anti-roll bar, and the method comprising: receiving a vehicle stationary signal indicative of the vehicle being stationary; outputting a passive state request signal to the actuator of the vehicle suspension system, wherein the passive state request signal is configured to prevent the actuator from responding to a received torque demand; receiving a passive state confirmation signal indicative that the actuator is in a passive state; providing a torque demand to the actuator in dependence on receipt of the passive state confirmation signal; receiving a sensor response signal from a sensor configured to sense a torque level of the anti-roll bar of the vehicle; and outputting a fault signal in dependence on receipt of the sensor response signal indicating the torque level of the anti-roll bar is above a predetermined threshold.

In another aspect there are provided computer readable instructions which, when executed by a processor of any control system disclosed herein, are arranged to perform any method disclosed herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an example control system for a vehicle according to examples disclosed herein;

FIG. 2a shows an example control system for a vehicle connected to front and rear anti-roll bars according to examples disclosed herein;

FIG. 2b shows an example control system for a vehicle comprising plural sub-systems, and front and rear anti-roll bars, according to examples disclosed herein;

FIG. 3 shows a flowchart showing a function test performed according to examples disclosed herein;

FIG. 4 shows a flowchart illustrating a vehicle stationary check to determine that a vehicle is ready for a test to be performed according to examples disclosed herein;

FIGS. 5a and 5b diagrammatically illustrate a torque profile according to examples disclosed herein;

FIG. 6 shows a method according to examples disclosed herein; and

FIG. 7 shows a vehicle in accordance with an embodiment of the invention.

### DETAILED DESCRIPTION

Active suspension systems, such as electronic active roll control utilizing mechatronic systems, may include a cascade of systems, such as:
(a) a high level vehicle control layer, which may generate system demand signals (for example torque demands) to influence vehicle motion;
(b) a low level control layer, which may provide control signals to actuators (for example motor control) to deliver the demanded signal from the high level control; and
(c) a physical actuation layer, comprising motors and associated mechanical components to deliver the physical manifestation of the demanded signal.

It is desirable to be able to pre-emptively diagnose a system failure which may arise within the electronic active roll control system, including the individual subcomponents of the system, before any undesired, potentially hazardous situation occurs. It may be desirable to frequently perform a functional safety test of communication between the controller and the electronic active roll control system, particularly during active use of the vehicle, to help prevent any such situation occurring. However, during active use of the vehicle, it may be difficult to perform a functional test on the electronic active roll control system, in order to pre-emptively diagnose any system faults, because such functional testing may variously impair the vehicle performance, and potentially may damage subcomponents of the system. For example, it is important that, if the vehicle is set in a passive state (so that an actuator does not provide a requested torque actuation when set in a “passive” state), the actuator does not deliver any requested torque. Examples disclosed herein may allow for pre-emptive functional testing of a vehicle active suspension system.

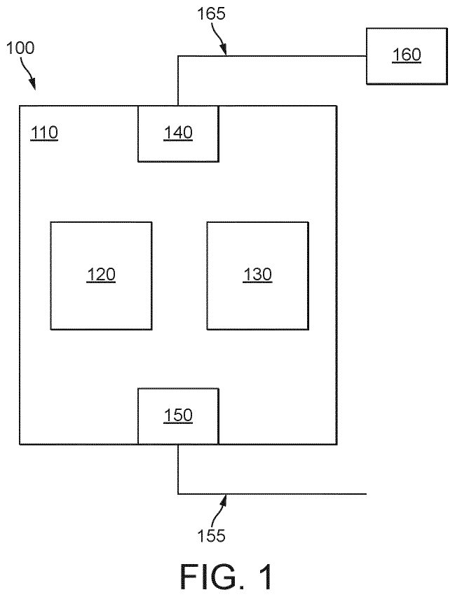

The control system 100 as illustrated in FIG. 1 comprises one controller 110, although it will be appreciated that this is merely illustrative. The controller 110 comprises processing means 120 and memory means 1130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 150 of the control system 100. The input 140 is configured to receive one or more input signals 165, for example from a sensor 160. There may be one or more sensors which provide information to the controller input 140. The output 150 is configured to provide one or more output signals 155.

In an example, the input 140 is arranged to receive a receive a vehicle stationary signal as an input signal 165. The vehicle stationary signal may be an electrical signal which is indicative of the vehicle being stationary for example both laterally and longitudinally stationary. The vehicle stationary signal may be any signal which indicated that the system is in a ready state to be tested. The vehicle stationary signal may comprise information from a plurality of vehicle sensors or communication channels to determine if the vehicle is in a correct state to perform the test. The inputs may be electrical inputs or messages exchanged with other controller or modules via a vehicle communication bus. For example, the vehicle stationary signal may comprise a digital signal (0/1), a state encoded signal (for example ready=2, not ready=3), or an electrical signal (for example 0V=ready, 5V=not ready). Other possible implementations are feasible.

The output 150 is arranged to output a passive state request signal as an output signal 155 to the actuator of the vehicle suspension system in dependence on receipt of the vehicle stationary signal (i.e. indicating that the vehicle is in an appropriate operating state for the test to be performed). is configured to prevent the actuator from responding to a received torque demand. The passive state request signal may be any signal which causes the actuators to not physically implement a received torque demand. For example, the passive state request signal may comprise a digital signal (0/1), a state encoded signal (for example passive demand=4, active demand=5), or an electrical signal (for example 0V=passive state, 5V=active state). Other possible implementations are feasible.

The input 140 is also arranged to receive a passive state confirmation signal as an input signal 165. The passive state confirmation signal is an electrical signal which is indicative of the actuator being in a passive state. The output 150 is also arranged to output a torque demand as an output signal 155 to the actuator in dependence on the passive state confirmation signal. The input 140 is also arranged to receive a sensor response signal configured to sense a torque level of the anti-roll bar. The output 150 is also arranged to output a fault signal as an output signal 155 in dependence on receipt of the sensor response signal indicating the torque level of the anti-roll bar is above a predetermined threshold. Further examples are discussed below.

By performing the above, the control system may perform a pre-emptive diagnostic check while the vehicle is being driven normally, to check the integrity of the actuator(s) of the anti-roll bar(s) of the vehicle. That is, latent faults which may not be evident without testing may be detected. By pre-empting an error state (i.e. by checking for vehicle movement caused by actuator movement, even though the actuator has been set to be in a passive state in which actuator requests are not performed) the functionality of the active roll control system may be tested in a non-intrusive way. Even though the actuator is energised (i.e. is able to provide a torque), the test allows for the communication with the actuator to be checked, and if the actuator does delivery the torque even through it is in a passive state, a fault may be registered.

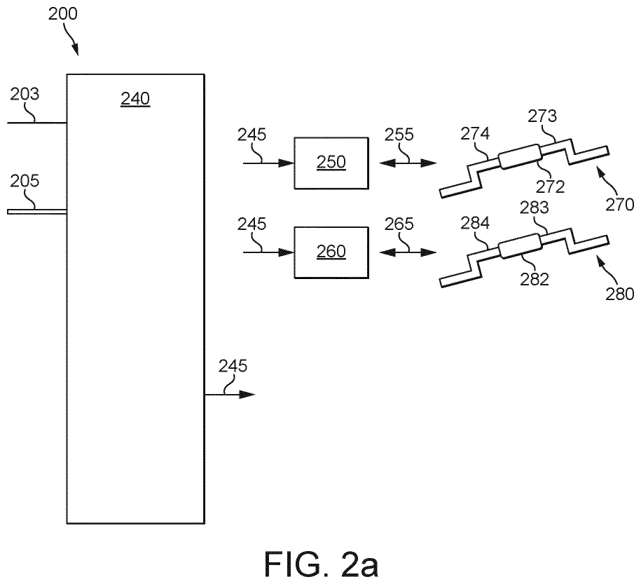

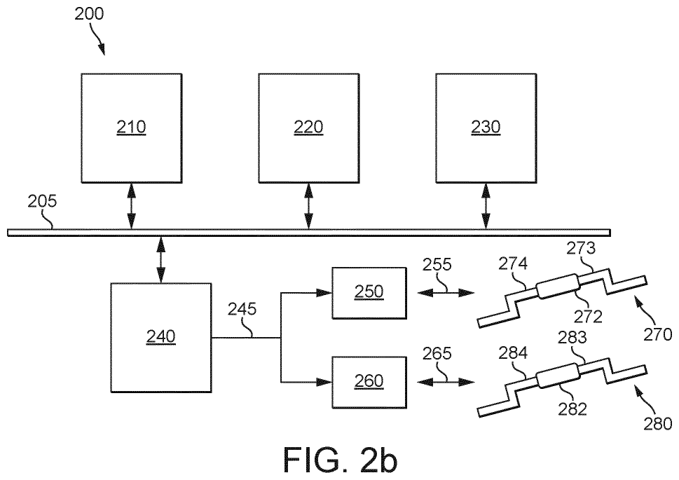

FIGS. 2a and 2b illustrate an example control system 200 for a suspension system of a vehicle. A suspension system of a vehicle may comprise anti-roll bars 270, 280 which are controlled using an anti-roll control system. The anti-roll control system acts to control the anti-roll bars, to control a roll of a body of the vehicle and reduce the impact of disturbances from a road surface. The anti-roll control system may be electromechanical and/or hydraulic. Anti-roll bars 270, 280 may typically comprise stabiliser bars, typically metal, which join the vehicle suspension on either side of the vehicle axle, usually through drop links, and connect to a rotational actuator situated between the mounting points to the vehicle chassis. Each side of the anti-roll bar is able to rotate freely when a motor of the anti-roll control system is not energised. When the motor control is enabled (i.e. delivering torque), the anti-roll bar may act as a torsional spring. The anti-roll bars may be controlled to compensate for some vehicle movements such as body roll, for example from driving around a corner. Body roll can cause the wheels at the side of the vehicle outside the turn to reduce their contact with the road surface. Anti-roll bars may be controlled to counteract this effect and reduce the body roll effect, by transferring at least part of the additional load on the wheels at the side of the vehicle inside the turn to those wheels at the outside, for example by providing a torsional effect to pull the wheels towards the chassis and even out the imbalance in load on the wheels caused by cornering.

A typical suspension system may comprise passive front and rear anti-roll bars provided respectively between the front and rear pairs of wheels of a standard four-wheel vehicle. In a vehicle with an active roll control system, an anti-roll bar 270, 280 may respectively comprise two anti-roll bar ends 273, 274; 283, 284 connected together by a central housing having an actuator 272, 282. The central housing may additionally have one or more of a gearbox, sensors, and dedicated actuator controllers. The actuator 272, 282 acts to provide an actively controlled torque rather than a fixed torsional stiffness provided by passive anti-roll bars. One or more sensors may monitor the movement of the vehicle, and provide the sensed parameters as input to the active roll control system to control the actuator and provide a suitable torque to the anti-roll bar. The two ends of the anti-roll bar (273, 274; 283, 284) may be identical, or may be non-identical.

FIG. 2a shows an example control system 200 for a suspension system a vehicle, communicatively connected to front and rear anti-roll bars 270, 280. The control system 200 comprises a controller 240 which is connected by a communication channel 245 to anti-roll bar controllers 250, 260 configured to respectively control front and rear anti-roll actuators 272, 282. The controller 240 may be the controller 110 of FIG. 1. The controller 240 may comprise one or more of the controllers 110 of FIG. 1. In an example, the controller 240 may be a master controller for an electronic active roll control system in the vehicle. The controller 240 may host a vehicle level control strategy and actuation control for the electronic active roll control system in the vehicle.

The controller 240 may be configured to receive one or more sensor signal 203 from one or more sensors attached to the vehicle. The one or more sensors signals 203 may comprise, for example, a signal from a respective suspension height sensor of the vehicle suspension; a signal from a respective hub acceleration sensor of the vehicle; and a signal from a respective torque sensor for the anti-roll bar actuators 272, 282. A signal from a respective motor position sensor for the anti-roll bar actuators 272, 282 may be communicated to the controller 240 via the communication link 245; A suspension height sensor may be configured to determine a sensor signal indicative of one or more of a height of a left side and a height of a right side of the vehicle suspension. A motor position sensor may be configured to determine a sensor signal indicative of a position of a respective motor of the anti-roll bar actuators 272, 282. A hub acceleration sensor may be configured to determine a sensor signal indicative of an acceleration of one or more hub of a wheel of the vehicle. A torque sensor may provide a measure of an existing torque generated in the system, as a result of a target torque demand being requested by the controller.

The controller 240 may be configured to receive one or more communication signals via a communications bus 205. The communications bus 205 may be configured to deliver data to the controller 240 from other subsystems within the vehicle. For example, the communications bus 205 may be configured to communicate a signal indicating a status of one or more modules 210, 220, 230 that are in communicative connection with the controller 240 to the controller 240. In another example, the communications bus 205 may be configured to communicate a command from the controller 240 to the one or more modules 210, 220, 230 that are in communicative connection with the controller 240. The one or more modules 210, 220, 230, are discussed further in relation to FIG. 2b below. Signals transmitted over connections 203 or 245 may alternatively or additionally be transmitted over communications bus 205.

The controller 240 may be configured to generate system demand signals to influence a vehicle's motion via the anti-roll actuators 272, 282. An actuator provided between a front pair of wheels of a vehicle may be called a front actuator. A front active roll control (FARC) module may be electrically connected to the front actuator, and may comprise the controller 250 to control the front actuator 272. Similarly, an actuator provided between a rear pair of wheels of a vehicle may be called a rear actuator. A rear active roll control (RARC) module may be electrically connected to the rear actuator and may comprise a controller 260 to control the rear actuator 282.

The front and rear anti-roll actuators 272, 282 each comprise an electric motor which is controllable by the respective anti-roll controller 250, 260. Each of the front and rear anti-roll actuators 272, 282 may be controlled by its own respective anti-roll controller in some examples, or multiple anti-roll actuators may be controlled by a common anti-roll controller in some examples. Each of the anti-roll actuators 272, 282 may be individually controlled in some cases to improve the management of the roll of the body of the vehicle. The front and rear anti-roll actuators 272, 282 may be controlled by a control signal which is generated by the controller 240 may generate and output, through the output channel 255, 265, to the anti-roll bar controllers 250, 260, which then use the communication channel 245 to exchange data with the controller 240. The control signal may carry instructions to be implemented by the actuator, for example by providing a torque to apply to the anti-roll bar. For example, as discussed above, when the vehicle is cornering, a control signal may be transmitted to the anti-roll bar controllers 250, 260, which may in turn transmit a control signal via interface 255, 265, so that the front and rear anti-roll actuators 272, 282 may mitigate a body roll effect. Similarly, anti-roll bar controllers 250, 260 may transmit measured values from the anti-roll actuators to the controller 240 through output channel 245.

FIG. 2b shows an example control system 200 for a vehicle comprising one or more modules 210, 220, 230, a controller 240 and front and rear anti-roll bar actuators 272, 282. As in FIG. 2a, the control system 200 comprises a controller 240 which is connected by a communication channel 245 to controllers 250, 260 configured to respectively control front and rear anti-roll bar actuators 272, 2820. Further, the controller 240 of the control system 200 is in a communicative connection to the one or more modules 210, 220, 230 via a communications bus 205. The one or more modules 210, 220, 230 may be configured to perform functions relating to power supply of the suspension system. Module 210 may be a power control module configured to control a power supply system for the suspension system. Module 220 may be a conversion module configured to convert electrical energy output from a vehicle power supply system. In an example, the conversion module 220 may comprise a DC-DC converter. Module 230 may be a capacitor or supercapacitor module configured to store electrical energy for the suspension system. Together, conversion module 220 and capacitor module 230 may be configured to supply electrical energy to the controllers 250, 260, such that the anti-roll bar actuators 272, 282 can be actuated. FIG. 2b illustrates these modules 210, 220, 230 as individual modules. However, there may be examples whereby components within the modules 210, 220, and 230 are included in a single module.

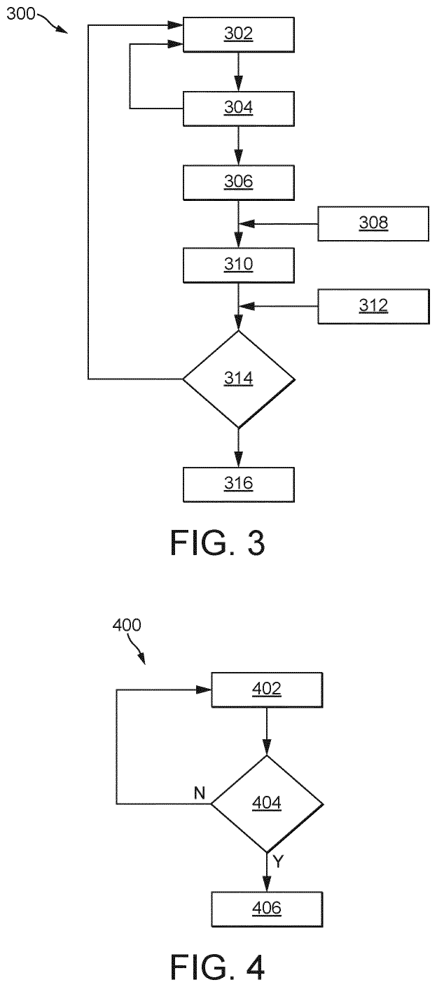

FIG. 3 shows a flow chart 300 illustrating the features of an example control system in performing a test cycle for testing communication between the control system and the vehicle suspension system. In other words, the test comprises a test sequence which aims to provide a pre-emptive way to check the expected operation of the vehicle active suspension system, or, the test aims to test the integrity of the active suspension control system. Starting with step 302, a vehicle 700 is currently in, or is initiated to enter, a normal driving mode. For example, the vehicle is may be currently being driven by a user during a drive cycle. Herein, a drive cycle may be defined as a time period between two consecutive power on or power off events.

From a normal driving mode at step 302, the control system receives a vehicle stationary signal at step 304 indicating that the vehicle is laterally and longitudinally stationary (i.e. that the vehicle has been brought to a stop). For example, the vehicle 700 may be temporarily stationary (i.e. at traffic lights, or idling), whilst a motor of the vehicle 700 continues to run. In another example, the vehicle may have received an ignition start up command, from the user, for initiating a drive cycle. In some examples, the vehicle 700 is currently stationary, without driving (i.e. vehicle travel) having yet started, and a vehicle stationary signal may be received as part of a vehicle readiness (or vehicle stationary) check at the start of the drive cycle whilst the vehicle is laterally and longitudinally stationary. The vehicle stationary signal in some examples may be received by the control system during performance of diagnostic check (or vehicle stationary) check, as indicated in accordance with FIG. 4 discussed below.

On confirmation of receipt of the vehicle stationary signal confirming that the vehicle is laterally and longitudinally stationary at step 304, the vehicle 700 is determined to be ready for the test to be performed, and proceeds to step 306. That is, the controller 200 determines if the vehicle is ready for the test to be performed. However, if the vehicle 700 is not determined to be ready (i.e. there is no vehicle stationary signal received, or the received signal resulting from the vehicle stationary check does not indicate that the vehicle is stationary, either laterally or longitudinally), the test is aborted, and returns to initial step 302. The determination that the vehicle is ready may be made based on meeting one or more pre-conditions to determine test readiness. The pre-conditions to be met may include one or more of: the vehicle being stationary, the vehicle body is not leaning to one side, and the vehicle body is not oscillating laterally.

At step 306, once the vehicle is confirmed as being stationary (for example on confirmation of receipt of the vehicle stationary signal), the vehicle is determined to be laterally and longitudinally stationary and therefore ready for testing, and the control system outputs a passive state request signal to an actuator of the suspension (for example to an actuator of the electronic active roll control) system 200. The passive state request signal requests the actuator 272, 282, to enter a passive state. Herein, the passive state may be considered a disabled, or standby state, wherein the actuator is energised/powered (i.e. is receiving power) but is instructed to not respond (i.e. not act) on any subsequently received torque demand signals. That is, the actuator is configured so as to not apply any torque to the suspension system. The passive state request signal may be called a torque control qualifier signal, or flag. The flag, or other torque control qualifier, induces a passive or active operating state of the active suspension system. The flag, for example, may be set to False to cause the actuator to operate in the passive state. The electronic active roll control system (active suspension system) is therefore disabled (i.e. will not act on any received torque demand) whilst the passive state (i.e. torque qualifier signal set to False) is maintained. On the other hand, a torque qualifier signal set to True would cause the actuator to operate in an “active” state, and respond to an issued torque demand.

Following output of the passive state request, the control system receives confirmation 308 of entering the passive state from the actuator 272, 282. The passive state confirmation 308 may be received from each of the front 272 and rear 282 actuators of the electronic active roll control system individually, or as a combined signal, for example if both front and rear actuators 272, 282 are to be checked together.

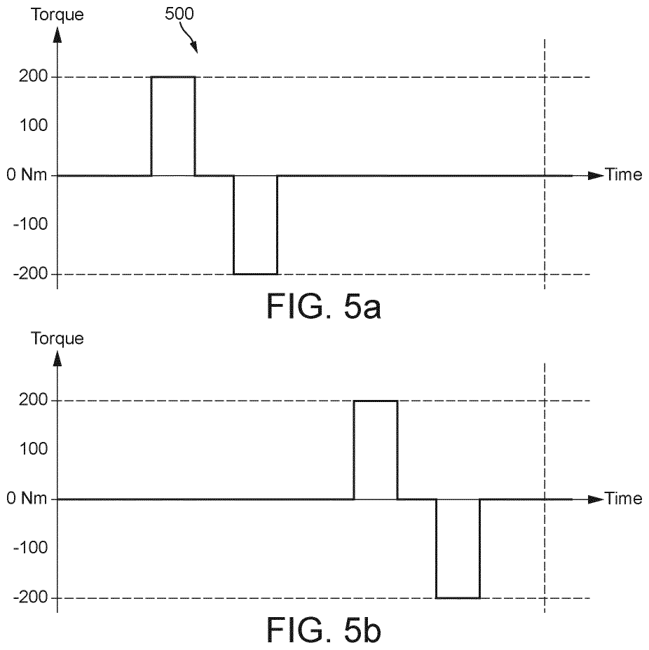

On receipt of confirmation 308, the control system outputs 310 a torque demand by the actuator 272, 282. The torque demand may be sent to the anti-roll bar controllers 250, 260 via the output channel 245, and the anti-roll bar controllers 250, 260 then convert the received torque demand to a motor control demand to deliver the torque. An example torque demand signal is illustrated in FIGS. 5a and 5b discussed below.

During vehicle use, a torque demand signal may delivered to the actuator 272, 282 from the control system. Such a torque demand signal may be delivered routinely (for example periodically, or continuously). However, when in the passive state (for example when a torque qualifier signal is set to False), this signal is not acted upon when it is received by the actuator. In other words, during operation of the electronic active roll control system in the passive state, substantially no torque is actively built up within the electronic active roll control system in response to the issued command.

While operating in the passive state, and following the delivery of a torque demand signal to the actuator, the control system 110 receives a sensor response signal 312 from at least one sensor configured to sense a torque level of the anti-roll bar of the electronic active roll control system (i.e. a torque level built up on the anti-roll bar in response to the issued torque demand to the actuator and/or to other torque providing element of the active suspension system). The sensor response signal may be received from a torque sensor located on the front axle roll bar, and/or a torque sensor located on the rear axle roll bar, for example. Particularly, at least one torque sensor may be comprised within a control module located at an axle. For example, a torque sensor may be incorporated into the roll bar assembly itself, together with a local ECU that processes the sensed data and outputs it elsewhere in the system. The torque event, however implemented, would be physically mounted as part of or close to the torque generating element in order to detect a generated torque.

If the received sensor response signal 312 indicates that the torque level of the anti-roll bar is above a predetermined threshold, the control system determines, at 314, that a fault is present in the electronic active roll control system. This is because the torque qualifier signal is set to False, so while the torque request is sent to the actuator, due to the “False” qualifier, the actuator should not act on the torque request to apply a torque. If a torque is applied (above a predetermined low threshold), then there is a fault because the actuator should not be acting on the received torque request but the detected movement, caused by the torque build-up, indicates that they have acted on the torque request despite the “False” qualifier. On receipt of the sensor response signal indicating that the torque level of the anti-roll bar has exceeded the predetermined threshold, the torque demand is reduced to zero (i.e. no further torque demand is output to the actuators). The active suspension system may also be entered into a safe state, for example by disconnecting the power supply to the actuators. A fault signal is output, at 316, to be displayed on the vehicle 700 (i.e. on a dashboard of the vehicle), indicating the presence of a fault.

If the received sensor response signal 312 indicates that the torque level of the anti-roll bar is below the predetermined threshold, then it is determined, i.e. at 314, that no fault is present (i.e. the electronic active roll control system is operating normally). The test cycle is returned to the start and the control system may then monitor for receipt of a further vehicle stationary signal, so that the test as discussed above may be re-performed the next time the vehicle is determined to be stationary.

During the drive cycle, the control system may receive a plurality of vehicle stationary indicators at different points in time. For example, a vehicle stationary indicator may be received each time the vehicle is (temporarily) stationary within traffic, or idling e g at a red traffic light. The control system may be configured to perform the test cycle of FIG. 3 each time a vehicle stationary indicator is received. Therefore, for each drive cycle, the control system may output a plurality of passive request signals in response to each respective vehicle stationary indicator received during the drive cycle.

When a plurality of test cycles are performed during the same drive cycle, the control system may record (i.e. in a record, or test log) one or more of the sensor response signals that are received in response to each of the output torque demands, and whether test results indicate that the test was pass or failed. If a pre-set number of the recorded responses fail to indicate the torque level being above a pre-determined stationary threshold (for example a pre-set number of successive sensor response signals indicate a test pass, or no fault, are received—determined either through the sensor values or by checking the number of test passes or fails recorded), then the control system may reduce the frequency at which the test cycle is repeated. In other words, the test cycle may be repeated less frequently than each time the vehicle is determined to be stationary (on receipt of a vehicle stationary indicator).

During a test cycle, the control system 110 may monitors for receipt of a vehicle movement signal. A vehicle movement signal is an indication of a movement of the vehicle 700, (such as a sensed vehicle movement displacement, or driver-initiated vehicle movement). Similarly to the vehicle stationary signal, the vehicle movement signal may be determined by receiving a sensor signal indicating a movement. Example signals include an signal indicating a movement, or rate of change, of at least one suspension height sensor of the vehicle 700, such as a suspension height sensor located at a front left wheel, a front right wheel, a rear left wheel, or a rear right wheel of the vehicle 700. A suspension height sensor may be fitted close to a wheel hub, behind the tyre. The suspension height sensor is a different sensor to the torque sensor for a particular wheel. The vehicle movement signal may comprise receiving information on a speed of the vehicle exceeding substantially zero.

After receiving the passive state request signal, and prior to provision of the torque demand, the control system may receive a vehicle movement indicator indicating a vehicle movement exceeding the predetermined value. In other words, it may be determined that the vehicle is no longer stationary (that is, the vehicle movement, laterally and/or longitudinally, is no longer below the predetermined value indicative of the vehicle being stationary). On receipt of the vehicle movement indicator, the current test cycle may be aborted. Aborting the test cycle may cause the test cycle process to return to the start 302, so that the test cycle can be re-performed from the beginning of the test cycle the next time the vehicle is determined to be stationary. Similarly, after outputting the torque demand, and prior to output of a fault signal, if the control system receives a vehicle movement indicator indicating a vehicle movement, the current test cycle may be aborted. One or more other conditions may cause the testing to be aborted, including: the passive state confirmation signal (i.e. the “test ready” indicator) is not True; there is a fault detected within the active suspension system which is independent of the failure mode the to-be-aborted test is testing for; or driver induced control of the vehicle is activated. Activation of driver-induced control may take priority over the described pre-emptive tests in terms of demanded torque.

While the above discussion refers to an actuator, it will be appreciated that a suspension system having plural actuators (for example front and rear axle anti-roll bar actuators, or one or more actuators per wheel) may also be tested in this way.

FIG. 4 shows a flowchart illustrating a vehicle stationary check. At step 402, the vehicle is operating in a normal driving mode (corresponding to step 302). When the vehicle comes to a stop, the control system performs a vehicle stationary check at step 404. The vehicle stationary check may determine that a movement of the vehicle 700 is below a predetermined movement value, both laterally and longitudinally. In some examples, the movement of the vehicle 700 may be determined by receiving a signal comprising an indication of a rate of change of at least one suspension height sensor of the vehicle 700.

The movement of the vehicle 700 may comprise lateral movement and/or longitudinal movement. Suspension height sensors may be used to measure vertical displacement and therefore a measure of body lateral movement, and thus in turn, whether the vehicle is stationary. The vehicle speed may be provided by wheel speed sensors, or other sensors sensitive to longitudinal movement. The rate of change may be indicative of minimal vehicle movement (i.e. the vehicle being laterally stationary) when it is below a predetermined value. A suspension height sensor may be located, for example, at a front left wheel, a front right wheel, a rear left wheel, or a rear right wheel of the vehicle 700. In some examples, determining the movement of the vehicle 700 may comprise receiving information on a speed of the vehicle. A speed which is at zero (or is at least below a predetermined value such that it is substantially zero may indicate no longitudinal movement. From this received movement information, the control system determines whether the vehicle is laterally and longitudinally stationary (i.e. the vehicle readiness). If indicating that the vehicle is stationary (Y) (i.e. the received movement information being a vehicle stationary signal indicative of the vehicle being stationary) the control system may proceed to the next stages 406 of the test cycle (referring to 306 of FIG. 3). However, if the vehicle stationary check does not indicate that the vehicle is stationary (N), the diagnostic check, and thus test cycle, is aborted, and the process returns to step 402, with the vehicle operating in normal control (normal driving mode).

FIGS. 5a and 5b show a diagram illustrating an example torque profile 500 which is toggled (switched) between a zero and non-zero value. It will be appreciated other torque profiles may also be used as discussed below. As illustrated in FIGS. 5a and 5b, the torque demand signal may be applied sequentially (i.e. alternatively) between a front actuator (i.e. front axle, FIG. 5a) and rear actuator (i.e. rear axle, FIG. 5b). The torque demand may be applied (or output) as a positive step input, as a negative step input, as a positive input step followed by a negative input step (as illustrated), or otherwise. In an example, as shown, the issued torque demand may be +200 Nm applied to the front axle, then −200 Nm applied to the front axle, followed by +200 Nm applied to the rear axle, then −200 Nm applied to the rear axle, as illustrated in FIGS. 5a and 5b. Each non-zero portion of torque may have a duration of for example 100 ms (in other examples the duration may be longer or shorter than this). Of course there are many possible torque profiles which may also be used. The torque profile amplitudes need not necessarily be the same amplitude (i.e. the positive and negative maximum values do not necessarily need to have the same absolute value). The particular values chosen may depend on specific vehicle properties. The waveform of the torque profile may also have another shape and need not necessarily be a step change maintained for a time period. For example, a sawtooth or triangular waveform, or a continuously varying waveform such as a sine wave, may be used. Also, the duration the torque remains at a minimum or maximum level may vary within a test or between different tests, and in some examples may have a duration which is calibratable.

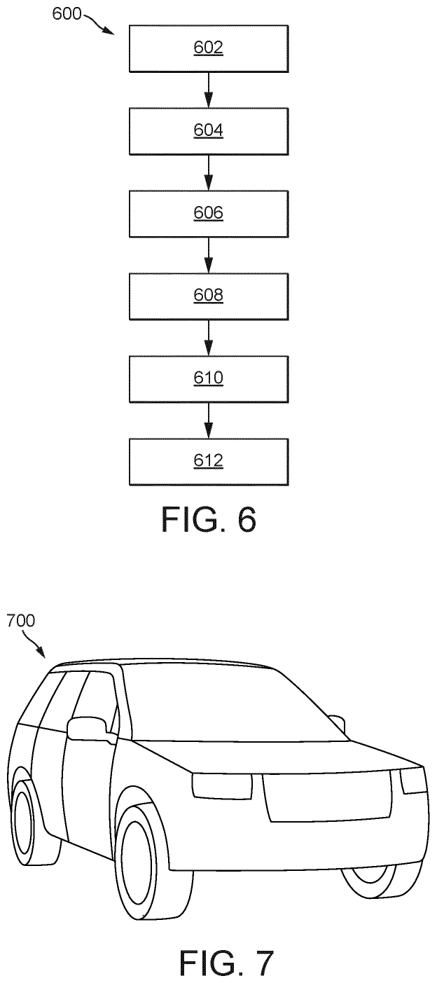

FIG. 6 illustrates a method 600 according to an embodiment of the invention. The method 600 is a method of a control system for a vehicle suspension system of a vehicle 700, such as the vehicle 700 illustrated in FIG. 7. The vehicle suspension system as discussed above comprises an actuator coupled to an anti-roll bar, wherein the actuator is configured to generate an active force. The method 600 may be performed by the system 100 illustrated in FIG. 1. In particular, the memory 130 may comprise computer-readable instructions which, when executed by the processor 120 of the control system 100, perform the method 600.

[symbol] receiving 602 a vehicle stationary signal indicative of the vehicle being stationary. A stationary vehicle may be both laterally and longitudinally stationary and the vehicle stationary signal may indicate the vehicle is stationary in both these directions.

The method 600 further comprises outputting 604 a passive state request signal to the actuator of the vehicle suspension system, wherein the passive state request signal is configured to prevent the actuator from responding to a received torque demand. The method 600 further comprises receiving 606 a passive state confirmation signal indicative that the actuator is in a passive state. That is, the method determines if the vehicle is ready for the test to be performed. The determination that the vehicle is ready may be made based on meeting one or more pre-conditions to determine test readiness, such as determining, or receiving an indication that, the vehicle is stationary, the vehicle body is not leaning to one side, and/or the vehicle body is not oscillating laterally.

The method 600 further comprises providing 608 a torque demand to the actuator in dependence on receipt of the passive state confirmation signal, and receiving 610 a sensor response signal from a sensor configured to sense a torque level of the anti-roll bar of the vehicle. The method 600 further comprises outputting 612 a fault signal in dependence on receipt of the sensor response signal indicating the torque level of the anti-roll bar is above a predetermined threshold.

The blocks illustrated in FIG. 6 may represent steps in a method 600 and/or sections of code in a computer program configured to control the control system as described above to perform the method steps. The illustration of a particular order to the blocks does not necessarily imply that there is a required or preferred order for the blocks and the order and arrangement of the block may be varied. Furthermore, it may be possible for some steps to be omitted or added in other examples. Therefore, this disclosure also includes computer software that, when executed, is configured to perform any method disclosed herein, such as that illustrated in FIG. 6. Optionally the computer software is stored on a computer readable medium, and may be tangibly stored.

FIG. 7 shows a vehicle 700 comprising a control system 100 as described above, or a system 100 as described above. The vehicle 700 in the present embodiment is an automobile, such as a wheeled vehicle, but it will be understood that the control system and active suspension system may be used in other types of vehicle.

As used here, ‘connected’ means ‘electrically interconnected’ either directly or indirectly. Electrical interconnection does not have to be galvanic. Where the control system is concerned, connected means operably coupled to the extent that messages are transmitted and received via the appropriate communication means.

It will be appreciated that various changes and modifications can be made to the present invention without departing from the scope of the present application. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A control system for a vehicle suspension system of a vehicle, the control system for performing a test cycle for testing communication between the control system and the vehicle suspension system, the control system comprising one or more controllers and the vehicle suspension system comprising an actuator coupled an anti-roll bar, the control system configured to:
receive a vehicle stationary signal indicative of the vehicle being stationary;
output a passive state request signal to the actuator of the vehicle suspension system in dependence on receipt of the vehicle stationary signal, wherein the passive state request signal is configured to prevent the actuator from responding to a received torque demand;
receive a passive state confirmation signal indicative that the actuator is in a passive state;
output a torque demand to the actuator in dependence on the passive state confirmation signal;
receive a sensor response signal from a sensor configured to sense a torque level of the anti-roll bar; and
output a fault signal in dependence on receipt of the sensor response signal indicating the torque level of the anti-roll bar is above a predetermined threshold.

17. The control system according to claim 16, wherein the torque demand switches the torque demand between a zero and non-zero value.

18. The control system according to claim 16, further configured to alternately provide the torque demand to: an actuator of a front axle of the vehicle, and an actuator of a rear axle of the vehicle.

19. The control system according to claim 18, wherein the sensor response signal is received from:
at least one torque sensor located on the front axle, and
at least one torque sensor located on the rear axle.

20. The control system according to claim 16, further configured to, in dependence on receipt of the sensor response signal indicating that the torque level of the anti-roll bar is above the predetermined threshold, reduce the torque demand to zero.

21. The control system according to claim 16, further configured to, when the vehicle is stationary at different points in time during a drive cycle:
receive a plurality of vehicle stationary indicators each indicative of the vehicle being stationary for each of the different points in time during the drive cycle; and
output a plurality of respective passive state request signals each in response to a respective vehicle stationary indicator of the plurality of vehicle stationary indicators.

22. The control system of claim 21, further configured to, during the drive cycle:
in dependence on receipt of a passive state confirmation signal in response to each of the plurality of respective passive state request signals, record a plurality of sensor response signals each received in response to a respective torque demand of each of the plurality of passive state confirmation signals; and
decrease a frequency for repeating the test cycle in response to receipt of further vehicle stationary indicators for a current drive cycle if a pre-set number of recorded responses fail to indicate the torque level is above a predetermined threshold.

23. The control system according to claim 16, further configured to:
determine that the vehicle is stationary when the vehicle stationary indicator indicates movement below a predetermined value.

24. The control system according to claim 23, wherein the vehicle stationary indicator is received from one or more of: a movement of at least one suspension height sensor of the vehicle, and a speed of the vehicle.

25. The control system according to claim 23, further configured to, following provision of the passive state request signal, and prior to provision of the torque demand:
monitor for receipt of a vehicle movement indicator indicating vehicle movement exceeding a predetermined value; and
in dependence on receipt of the vehicle movement indicator exceeding the predetermined value, abort a current test cycle.

26. The control system according to claim 25, wherein the vehicle movement indicator indicates at least one of: a movement of at least one suspension height sensor of the vehicle, and a speed of the vehicle.

27. A system, comprising:
the control system according to claim 16;
a vehicle suspension system comprising at least one actuator and an anti-roll bar; and
at least one sensor configured to sense a torque level of the anti-roll bar.

28. A vehicle comprising a control system according to claim 16.

29. A method for a control system for a vehicle suspension system in a vehicle, the control system comprising one or more controllers and the vehicle suspension system comprising an actuator coupled to an anti-roll bar, and the method comprising:
receiving a vehicle stationary signal indicative of the vehicle being stationary;
outputting a passive state request signal to the actuator of the vehicle suspension system, wherein the passive state request signal is configured to prevent the actuator from responding to a received torque demand;
receiving a passive state confirmation signal indicative that the actuator is in a passive state;
providing a torque demand to the actuator in dependence on receipt of the passive state confirmation signal;
receiving a sensor response signal from a sensor configured to sense a torque level of the anti-roll bar of the vehicle; and
outputting a fault signal in dependence on receipt of the sensor response signal indicating the torque level of the anti-roll bar is above a predetermined threshold.

30. Computer readable instructions arranged to perform a method according to claim 29.
